(19) United States
(12) Patent Application Publication
(10) Pub. No.: US 2023/0356185 A1
(43) Pub. Date: Nov. 9, 2023

(54) IMPROVEMENTS IN LIQUID CHROMATOGRAPHY SUBSTRATES

(71) Applicant: UNIVERSITY OF SOUTH AUSTRALIA, ADELAIDE (AU)

(72) Inventors: Emily Frances HILDER, Millswood (AU); Aminreza KHODABAN-DEH, Tranmere (AU); Ruben Dario ARRUA, Tranmere (AU)

(73) Assignee: UNIVERSITY OF SOUTH AUSTRALIA, ADELAIDE (AU)

(21) Appl. No.: 18/246,371

(22) PCT Filed: Sep. 27, 2021
(86) PCT No.: PCT/AU2021/051123

§ 371 Date: Mar. 23, 2023

(30) Foreign Application Priority Data
Sep. 25, 2020 (AU) 2020903467

(51) Int. Cl. B01J 20/285; B01J 20/28; B01J 20/26; B01J 20/30

(52) U.S. Cl. CPC B01J 20/261; B01J 20/28064; B01J 20/285; B01J 20/3064; B01J 2220/54

(57) ABSTRACT

A method for producing a porous copolymer monolith substrate for use in flow through liquid chromatography applications is disclosed. The method comprises forming a reaction composition comprising at least one monoethylenically unsaturated aryl monomer, at least one polyethylenically unsaturated aryl monomer, a RAFT agent, at least one liquid porogen, and a radical initiator. The reaction composition is introduced to a mold having a shape and dimensions suitable for forming a liquid chromatography substrate. The monoethylenically unsaturated aryl monomer, the polyethylenically unsaturated aryl monomer and the RAFT agent are copolymerised in the mold under conditions to form a solid copolymer network that is phase-separated from the reaction composition and/or any liquid components.

### PRIORITY DOCUMENT

The present application claims priority from Australian Provisional Patent Application No. 2020903467 titled “IMPROVEMENTS IN LIQUID CHROMATOGRAPHY SUBSTRATES” and filed on 25 Sep. 2020, the content of which is hereby incorporated by reference in its entirety.

### TECHNICAL FIELD

The present disclosure relates to liquid chromatography (LC) substrates and to processes for making the same. More specifically, the present disclosure relates to porous polymer LC substrates and to processes for making the same.

### BACKGROUND

The detection and quantification of molecules of interest in complex samples is an important application in areas of medicine, forensics, agriculture, and food science. To date, various methods have been used for detecting and quantifying molecules of interest (‘analytes’) in liquid or gas samples. Among the most popular methods is liquid chromatography (LC), more specifically liquid-solid chromatography which involves separating components of a liquid mixture by passing the mixture through a solid separation medium whereby components of the mixture can be separated by adsorption onto the surface of the solid separation medium (or stationary phase) and displacement by competition with the components of the mobile phase.

Monolith type separation media are commonly used in catalysis, flow- reactions, and LC applications and these media are generally silica-based or organic polymer-based.¹ Unfortunately, the performance of silica-based LC columns tends to deteriorate when used under conditions of low pH (e.g. pH 2 or lower) or high pH (e.g. pH 9 or higher). ⁴ In contrast, organic polymer-based LC columns can demonstrate improved stability at a range of pH² and temperature³.

Polymer-based monolithic separation media are normally obtained by conventional free radical polymerization methods. Despite these methods being relatively straightforward, they have serious limitations in terms of controlling the structural and/or material homogeneity of the materials.^{4a,4b} The semi-bulk polymerization method is the primary strategy for preparation of prior art three dimensional cross-linked porous polymers that are used as media in separation science⁵, due to the versatility, simplicity and efficiency of the method for preparing materials with a wide range of surface chemistries.

These porous polymers are often prepared via free radical polymerization of acrylate/methacrylate- and styrene-based monomers. Unfortunately, these porous polymers suffer from structural heterogeneity⁹⁻¹⁰ which negatively impacts the performance of the materials when used as stationary phases for liquid chromatography.

Thus, there is a need for methods for producing porous polymers for stationary phases for LC that are able to control the developing crosslinked network to provide materials with a hierarchically porous skeleton and consequently better separation performances.

### SUMMARY

The present disclosure arises from the inventors’ research directed to a reversible addition-fragmentation chain transfer (RAFT) polymerization method for the fabrication of porous polymers with well-defined porous morphology and surface chemistry in a confined capillary format.

In a first aspect, disclosed herein is a method for producing a porous copolymer monolith substrate for use in flow through liquid chromatography applications, the method comprising:
forming a reaction composition comprising at least one monoethylenically unsaturated aryl monomer, at least one polyethylenically unsaturated aryl monomer, a RAFT agent, at least one liquid porogen, and a radical initiator;
introducing the reaction composition to a mold having a shape and dimensions suitable for forming a liquid chromatography substrate;
copolymerising the monoethylenically unsaturated aryl monomer, the polyethylenically unsaturated aryl monomer and the RAFT agent in the mold under conditions to form a solid copolymer network that is phase separated from the reaction composition and/or any liquid components;
separating the solid copolymer network from the reaction composition and/or any liquid components to provide the porous copolymer monolith substrate.

In certain embodiments, the method of the first aspect further comprises removing porogen from the porous copolymer monolith substrate.

In a second aspect, disclosed herein is a porous copolymer monolith substrate for use in flow through liquid chromatography applications comprising a porous copolymer monolith covalently attached to an internal surface of a liquid chromatography column, wherein the porous copolymer monolith has been formed by copolymerising a reaction composition comprising a monoethylenically unsaturated aryl monomer, a polyethylenically unsaturated aryl monomer and a RAFT agent under conditions to form a solid copolymer network that is phase separated from the reaction composition and/or any liquid components and is covalently attached to the internal surface of the liquid chromatography column, and wherein the copolymerising is carried out in the presence of at least one porogen.

In a third aspect, disclosed herein is a separation medium comprising a porous polymer monolith formed by the method of the first aspect.

In a fourth aspect, disclosed herein is a use of the porous copolymer monolith substrate of the second aspect or the separation medium of the third aspect for liquid chromatography.

In certain embodiments, the RAFT agent is selected from the group consisting of 2-cyano-2-propyl dodecyl trithiocarbonate (CPDTC), 2-[[(butylsulfanyl)-carbonothioyl]sulfanyl] propanoic acid (PABTC), and 4-cyano-4-[(dodecylsulfanylthiocarbonyl)sulfanyl]pentanoic acid (CDSTS). In certain specific embodiments, the RAFT agent is selected from the group consisting of 2-[[(butylsulfanyl)-carbonothioyl]sulfanyl] propanoic acid (PABTC), and 4-cyano-4-[(dodecylsulfanylthiocarbonyl)sulfanyl]pentanoic acid (CDSTS).

In certain embodiments, the monoethylenically unsaturated aryl monomer is an aryl monovinyl monomer. In certain specific embodiments, the aryl monovinyl monomer is selected from one or more of the group consisting of styrene, vinylnaphthalene, vinylanthracene and their ring substituted derivatives wherein the substituents include C₁-C₁₈ alkyl, hydroxyl, C₁-C₁₈ alkyloxy, halogen, nitro, amino or C₁-C₁₈ alkylamino groups. For example, the aryl monovinyl monomer may be styrene or a ring substituted derivative thereof wherein the substituents include C₁-C₁₈ alkyl, hydroxyl, C₁-C₁₈ alkyloxy, halogen, nitro, amino or C₁-C₁₈ alkylamino groups.

In certain embodiments, the polyethylenically unsaturated aryl monomer is an aryl polyvinyl monomer. In certain specific embodiments, the aryl polyvinyl monomer is selected from one or more of the group consisting of divinylbenzene and divinylnaphthalene and their ring substituted derivatives wherein the substituents include C₁-C₁₈ alkyl, hydroxyl, C₁-C₁₈ alkyloxy, halogen, nitro, amino or C₁-C₁₈ alkylamino groups. For example, the aryl polyvinyl monomer may be divinylbenzene or a ring substituted derivative thereof wherein the substituents include C₁-C₁₈ alkyl, hydroxyl, C₁-C₁₈ alkyloxy, halogen, nitro, amino or C₁-C₁₈ alkylamino groups.

In certain embodiments, the porogen comprises a porogenic solvent and a porogenic non-solvent. The porogenic solvent may be selected from the group consisting of toluene, tetrahydrofuran and dioxane. The porogenic non-solvent may be selected from the group consisting of aliphatic hydrocarbon, aromatic hydrocarbon, ester, amide, alcohol, ketone, ether, and solutions of soluble polymers. In certain embodiments, the pore forming non-solvent is a C₆-C₂₂ aliphatic alcohol. For example, the pore forming non-solvent may be selected from the group consisting of decanol and dodecanol. In certain specific embodiments, the pore forming non-solvent is dodecanol.

In certain embodiments, the porogen comprises at least 25 wt% of the porogenic solvent.

In certain embodiments, the BET surface area of the porous copolymer monolith substrate is greater than 10 m²/g, such as greater than 40 m²/g, greater than 100 m²/g or greater than 500 m²/g.

### BRIEF DESCRIPTION OF THE FIGURES

Embodiments of the present disclosure will be discussed with reference to the accompanying figures wherein:

FIG. 1 shows chemical structures of the materials used in this study. The selected chain transfer agents are compatible with the styrene-based monomers;

FIG. 2 shows scanning electron micrographs and photographs of porous polymer made by RAFT-controlled polymerization-induced phase separation (PIPS) using CPDTC. The concentration of CPDTC is increasing from A2 to A4, while [AIBN] and [monomers] were constant. A1 is polymerized via free radical polymerization;

FIG. 3 shows N₂ adsorption (filled-circle) - desorption (circle) isotherms monoliths prepared with a different amount of CPDTC as RAFT agent (A1 (has no RAFT), A2, A3 and A4);

FIG. 4 shows scanning electron micrographs of porous polymer made by RAFT-controlled PIPS prepared with: (B1) PABTC and (B2) CDSTS. The same mole of the RAFT agent as sample A2 was used (See Table 1). The bottom is nitrogen adsorption / desorption isotherms of B1 and B2 samples in comparison with isotherm A2.

FIG. 5 shows kinetic data derived from ¹H NMR spectroscopy studies for the in situ RAFT polymerization of Sty-co-DVB at 60° C. within a NMR tube. The same data are presented as (a) a conversion-time plot, and (b) a semi-logarithmic plot (See Table 1). The CTA for A2 and A4 is CPDTC (A2: [CPDTC]:[AIBN] = 1 and A4: [CPDTC]:[AIBN] =2), for B1 is PABTC and for B2 is CDSTS. Dash lines are presenting the gelation time during the polymerization, where this was not observable for the sample A1 prepared via free radical polymerization method.

FIG. 6 shows (A) Overall EDX mapping elements on surface of A2 polymer: corresponding to sulfur, oxygen, and carbon mapping. (B) Relative counts of selected peaks of ToF-SIMS sensitivities for positive secondary ions for comparison of samples prepared with different RAFT agents: A2 - with CPDTC, B1 - with PABTC, and B2 - with CDSTS.

FIG. 7 shows SEM images of A2: In situ polymerization in 200 µm ID capillaries. The surface of the columns was chemically modified activated with different surface treatment: A with 3-trimethoxysilyl propyl methacrylate and B with 3-(Trimethoxysilyl)propyl acrylate;

FIG. 8 shows cross-sections of polymeric monolithic columns prepared via RAFT polymerization using different concentrations of CPDTC (A2-A4). The CTA for B1 is PABTC and for B2 is CDSTS;

FIG. 9 shows the effect of toluene amount on the morphology of the obtained materials inside 200 µm ID columns using CPDTC as RAFT agent (Left) and in bulk polymerization (Right) (w.r.t. the pore forming portion - (See Table 1);

FIG. 10 shows the effect of toluene amount on the morphology of the obtained materials without any RAFT agent: inside 200 µm ID columns (Left) and in bulk polymers (Right);

FIG. 11 shows polymer monoliths prepared inside 200 µm ID columns using CPDTC and THF (Top- D1) or dioxane (Bottom- D2);

FIG. 12 shows plots of the back-pressure versus flow rates for washing columns with methanol: A1 (no-CTA), A2 (RAFT agent CPDTC with toluene) and D1 (RAFT agent CPDTC with THF);

FIG. 13 shows the protein separation performance of the column A2, comparing to the column A1 (No-RAFT); (a) Ribonuclease, (b) Insulin, (c) Cytochrome, (d) Lysozyme and (e) Myoglobin. Chromatographic separation of five proteins. Conditions: 25 cm × 200 µm ID column; eluent A: 95:5 v/v water: acetonitrile 0.1% trifluoroacetic acid (TFA); eluent B: 5:95 v/v water: acetonitrile 0.1% TFA; linear gradient 1 to 65% B over 10 minutes; flow rate: 6 µL.min⁻¹; UV detection at 214 nm;

FIG. 14 shows the peptide separation performance of the column A2, comparing to the column A1 (No-CTA). Peak identification: (1) Bradykinin Fragment 1-5, (2) [Arg⁸]-Vasopressin acetate salt, (3) Enkephalin acetate salt, (4) Leucine encephalin, (5) Bradykinin acetate salt, (6) Angiotensin II and (7) Substance P acetate salt hydrate. Chromatographic Conditions: 25 cm × 200 µm ID column; eluent A: 95:5 v/v water: acetonitrile 0.1% trifluoroacetic acid (TFA); eluent B: 5:95 v/v water: acetonitrile 0.1% TFA; linear gradient 1 to 25% B over 10 minutes; flow rate: 6 µL min⁻¹. UV detection at 214 nm;

FIG. 15 shows the peptide separation performance of the column D1, comparing to the column D1-prepared with No-RAFT and THF as an organic solvent in pore forming agent);

FIG. 16 shows a schematic of an end-group removal process;

FIG. 17 shows the peptide separation performance of the column A2 after the end-group process;

FIG. 18 shows plate height curves obtained from separations on a monolithic columns; RAFT-prepared poly(styrene- co-divinylbenzene) column (left) and PepSwift™ (right) for non-retained tracers (uracil - Upper row) and retained tracer (ethylbenzene);

FIG. 19 shows the separation of small molecules performance of the column A2; 1)Toluene, 2)Ethylbenzene, 3)Propylbenzene, 4)Butylbenzene. Conditions: 25 cm × 200 µm ID column; eluent acetonitrile: water 70:30 @flow rate: 7, 8 and 9 µL.min⁻¹; UV detection at 214 nm.

### DESCRIPTION OF EMBODIMENTS

Disclosed herein is a method for producing a porous copolymer monolith substrate for use in flow through liquid chromatography applications. The method comprises forming a reaction composition comprising at least one monoethylenically unsaturated aryl monomer, at least one polyethylenically unsaturated aryl monomer, a RAFT agent, at least one liquid porogen, and a radical initiator. The reaction composition is introduced to a mold having a shape and dimensions suitable for forming a liquid chromatography substrate. The monoethylenically unsaturated aryl monomer, the polyethylenically unsaturated aryl monomer and the RAFT agent are copolymerised in the mold under conditions to form a solid copolymer network that is phase separated from the reaction composition and/or any liquid components. The solid copolymer network is then separated from the reaction composition and/or any liquid components to provide the porous copolymer monolith substrate.

Details of terms and methods are given below to provide greater clarity concerning materials, compositions, methods and use(s) thereof for the purpose of guiding those of ordinary skill in the art in the practice of the present disclosure. The terminology in this disclosure is understood to be useful for the purpose of providing a better description of particular embodiments and should not be considered limiting.

As used herein, the term “about” means plus or minus 5% from a set amount. For example, “about 10” refers to 9.5 to 10.5. A ratio of “about 5:1” refers to a ratio from 4.75:1 to 5.25:1.

As used herein, the term “alkyl” means any saturated, branched or unbranched or cyclised aliphatic hydrocarbon group and includes methyl, ethyl, propyl, isopropyl, butyl, isobutyl, t-butyl, pentyl, cyclopentyl, isopentyl, neopentyl, hexyl, isohexyl, cyclohexyl and the like, which may be optionally substituted with methyl. C₁-C₁₈ alkyl means an alkyl group having a total of from 1 to 18 carbon atoms.

As used herein, the term “analyte” includes but is not limited to small molecules and low molecular weight compounds, pharmaceutical agents, peptides, proteins, oligonucleotides, oligosaccharides, lipids and inorganic compounds.

As used herein, the term “aryl” means compounds having unsaturated cyclic rings with an odd number of pairs of pi orbital electrons that are delocalized between the carbon atoms forming the ring. Benzene and naphthalene are prototypical aryl compounds. Unless otherwise specified, the unsaturated aromatic cyclic ring may be unsubstituted or substituted.

As used herein, the term “initiator” means to any free radical generator capable of initiating polymerization by way of thermal initiation, photoinitiation, or redox initiation.

As used herein, the term “ethylenically unsaturated” means an aliphatic hydrocarbon group containing at least one carbon-carbon double bond and which may be straight or branched preferably having 2-12 carbon atoms in the normal chain. Exemplary ethylenically unsaturated groups include, but are not limited to, ethenyl, propenyl, butenyl, pentenyl, hexenyl, heptenyl, octenyl and nonenyl. A monoethylenically unsaturated molecule contains one carbon-carbon double bond that is reactive under the radical polymerization conditions described herein. A polyethylenically unsaturated molecule contains two, three or four carbon-carbon double bonds, each of which is reactive under the radical polymerization conditions described herein.

As used herein, the term “monolith” means an interconnected continuous piece of macroporous polymer.

As used herein, the term “polymer” means a molecule containing repeating structural units (monomers). A copolymer is a polymer formed from two or more different monomers. The term “monomer” includes comonomers.

As used herein, the term “polymerization” means a chemical reaction, usually carried out with a catalyst, heat or light, in which monomers combine to form a polymer. The polymerization reactions described herein are addition polymerization reactions which occur when a free radical initiator reacts with a double bond in the monomer and/or the RAFT agent.

As used herein, the term “substituted” means that the group may or may not be further substituted or fused (so as to form a condensed polycyclic system), with one or more non-hydrogen substituent groups. In certain embodiments the substituent groups are one or more groups independently selected from the group consisting of halogen, ═O, ═S, —CN, —NO₂, —CF₃, —OCF₃, alkyl, alkenyl, alkynyl, haloalkyl, haloalkenyl, haloalkynyl, heteroalkyl, cycloalkyl, cycloalkenyl, heterocycloalkyl, heterocycloalkenyl, aryl, heteroaryl, cycloalkylalkyl, heterocycloalkylalkyl, heteroarylalkyl, arylalkyl, cycloalkylalkenyl, heterocycloalkylalkenyl, arylalkenyl, heteroarylalkenyl, cycloalkylheteroalkyl, heterocycloalkylheteroalkyl, arylheteroalkyl, heteroarylheteroalkyl, hydroxy, hydroxyalkyl, alkyloxy, alkyloxyalkyl, alkyloxycycloalkyl, alkyloxyheterocycloalkyl, alkyloxyaryl, alkyloxyheteroaryl, alkyloxycarbonyl, alkylaminocarbonyl, alkenyloxy, alkynyloxy, cycloalkyloxy, cycloalkenyloxy, heterocycloalkyloxy, heterocycloalkenyloxy, aryloxy, phenoxy, benzyloxy, heteroaryloxy, arylalkyloxy, amino, alkylamino, acylamino, aminoalkyl, arylamino, sulfonylamino, sulfinylamino, sulfonyl, alkylsulfonyl, arylsulfonyl, aminosulfonyl, sulfinyl, alkylsulfinyl, arylsulfinyl, aminosulfinylaminoalkyl, —C(═O)OH, —C(═O)R^{a}, —C(═O)OR^{a}, C(═O)NR^{a}R^{b}, C(═NOH)R^{a}, C(═NR^{a})NR^{b}R^{c}, NR^{a}R^{b}, NR^{a}C(═O)R^{b}, NR^{a}C(═O)OR^{b}, NR^{a}C(═O)NR^{b}R^{c}, N R^{a}C(═ N R^{b}) N R°R^{d}, NR^{a}SO₂R^{b},—SR^{a}, SO₂NR^{a}R^{b}, —OR^{a}, OC(═O)NR^{a}R^{b}, OC(═O)R^{a} and acyl, wherein R^{a}, R^{b}, R^{c} and R^{d} are each independently selected from the group consisting of H, C₁-C₁₂alkyl, C₁-C₁₂haloalkyl, C₂-C₁₂alkenyl, C₂-C₁₂alkynyl, C₂-C₁₀ heteroalkyl, C₃-C₁₂cycloalkyl, C₃-C ₁₂cycloalkenyl, C₂-C₁₂heterocycloalkyl, C₂-C₁₂heterocycloalkenyl, C₆-C₁₈aryl, C₂-C₁₈heteroaryl, and acyl, or any two or more of R^{a}, R^{b}, R^{c} and R^{d}, when taken together with the atoms to which they are attached form a heterocyclic ring system with 3 to 12 ring atoms.

A person of ordinary skill in the art would recognize that the definitions provided above are not intended to include impermissible substitution patterns (e.g., methyl substituted with 5 different groups, and the like). Such impermissible substitution patterns are easily recognized by a person of ordinary skill in the art. Any functional group disclosed herein and/or defined above can be substituted or unsubstituted, unless otherwise indicated herein. Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. The term “comprises” means “includes”. Therefore, comprising “A” or “B” refers to including A, including B, or including both A and B. It is further to be understood that all base sizes or amino acid sizes, and all molecular weight or molecular mass values, given for nucleic acids or polypeptides are approximate, and are provided for description. Although methods and materials similar or equivalent to those described herein can be used in the practice or testing of the present disclosure, suitable methods and materials are described herein. In case of conflict, the present specification, including explanations of terms, will control. In addition, the materials, methods, and examples are illustrative only and not intended to be limiting.

As used herein, the terms “porogen” means a substance or mixture of substances capable of forming pores in a polymer matrix during polymerization thereof, and includes, but is not limited to, aliphatic hydrocarbons, aromatic hydrocarbons, esters, amides, alcohols, ketones, ethers, solutions of soluble polymers, and mixtures thereof. A porogen may also be referred to as a “pore forming agent”. A “porogenic solvent” is a porogen that also acts as a solvent for other substances. A “porogenic non-solvent” is a porogen in which other substances are not substantially soluble and, therefore, the porogen is not a solvent for those substances.

As used herein, the term “porous polymer monolith” means a continuous porous polymer matrix having an integral body with a particular pore size range.

As used herein, the term “unsubstituted” means that there is no substituent or that the only substituents are hydrogen.

As used herein, the term “liquid chromatography” include within its scope any known liquid chromatography technique or mode and includes normal phase chromatography, reversed phase chromatography, size exclusion chromatography, and/or ion exchange chromatography.

The present inventors have achieved a controlled-polymerization induced phase separation (Controlled-PIPS) synthesis of poly (styrene-co-divinylbenzene) in the presence of a RAFT agent dissolved in an organic solvent. The effect of the radical initiator/RAFT molar ratio as well as the percentages and type of the organic solvent were determined in order to introduce chemically cross-linked porous polymers into the inner wall of a silica-fused capillary. The morphological and surface properties of the obtained polymers were characterised, revealing the physico-chemical properties of the styrene-based materials. When compared with the prior art methods, the controlled PIPS approach affects the kinetics of polymerization by delaying the onset of phase separations which allowed a high level of control leading to materials with smaller pore size. The results demonstrated that controlled PIPS could be used for the design of porous monolithic columns suitable for the biomolecules liquid separation, i.e. peptides and proteins.

The method described herein produces a porous copolymer monolith substrate that can be used to separate small molecules, peptides, proteins, oligonucleotides, oligosaccharides, lipids, inorganic compounds or other analytes of interest from mixtures containing them in flow through liquid chromatography (LC) applications (sometimes referred to in this context as liquid-solid chromatography). Liquid chromatography can be used for analytical or preparative applications. Liquid chromatography applications in which the substrates can be used include low pressure liquid chromatography (LPLC), medium pressure liquid chromatography (MPLC) and high performance liquid chromatography (HPLC).

The porous copolymer monolith substrates formed by the methods described herein are highly crosslinked structures that can function as a stationary support. The internal structure of the copolymer monolith substrates consists of a fused array of microglobules that are separated by pores and their structural rigidity is preserved by extensive crosslinking. Formation of the monolith is triggered by a breakdown of the initiator by an external source (e.g. photoinitiation) creating a radical which induces the formation of polymer chains that precipitate out of the polymerization mixture eventually agglomerating together to form a continuous solid structure. The morphology of the monolith can be controlled by numerous variables; the crosslinking monomer(s) employed, the composition and percentage of the porogens, the concentration of the free-radical initiator and the method used to initiate polymerization.

The porous copolymer monolith substrates are continuous rigid structures and they can be fabricated in situ in a range of formats, shapes or sizes. The porous copolymer monolith substrates can be fabricated within the confines of chromatographic columns or capillaries for numerous chromatographic applications. However, given an appropriate mold, it is also possible to fabricate monoliths in the format of flat sheets. Flat monolithic sheets provide a particularly suitable medium for the storage of whole blood which allows for ease in both storage and transportation of blood samples.

The method for producing a porous copolymer monolith substrate begins with preparing a reaction composition comprising at least one monoethylenically unsaturated aryl monomer, at least one polyethylenically unsaturated aryl monomer, a RAFT agent, at least one liquid porogen, and a radical initiator.

The monoethylenically unsaturated aryl monomer can be any suitable aryl molecule that contains one carbon-carbon double bond that is reactive under the radical polymerization conditions. For example, the monoethylenically unsaturated aryl monomer may be an aryl monovinyl monomer. In certain embodiments, the monoethylenically unsaturated aryl monomer is an aryl monovinyl monomer selected from one or more of the group consisting of styrene, vinylnaphthalene, vinylanthracene and their ring substituted derivatives wherein the substituents include C₁-C₁₈ alkyl, hydroxyl, C₁-C₁₈ alkyloxy, halogen, nitro, amino or C₁-C₁₈ alkylamino groups. In certain specific embodiments, the aryl monovinyl monomer is styrene or a ring substituted derivative thereof wherein the substituents include C₁-C₁₈ alkyl, hydroxyl, C₁-C₁₈ alkyloxy, halogen, nitro, amino or C₁-C₁₈ alkylamino groups.

The polyethylenically unsaturated aryl monomer is a crosslinking monomer and can be any suitable aryl molecule that contains two or more carbon-carbon double bonds that are each reactive under the radical polymerization conditions. For example, the polyethylenically unsaturated aryl monomer may be an aryl polyvinyl monomer. In certain embodiments, the polyethylenically unsaturated aryl monomer is an aryl polyvinyl monomer selected from one or more of the group consisting of divinylbenzene and divinylnaphthalene and their ring substituted derivatives wherein the substituents include C₁-C₁₈ alkyl, hydroxyl, C₁-C₁₈ alkyloxy, halogen, nitro, amino or C₁-C₁₈ alkylamino groups. In certain specific embodiments, the aryl polyvinyl monomer is divinylbenzene or a ring substituted derivative thereof wherein the substituents include C₁-C₁₈ alkyl, hydroxyl, C₁-C₁₈ alkyloxy, halogen, nitro, amino or C₁-C₁₈ alkylamino groups.

The monoethylenically unsaturated aryl monomer and the polyethylenically unsaturated aryl monomer react with one another in a copolymerization reaction. The copolymerization reaction is a reversible addition-fragmentation chain transfer or RAFT polymerization that makes use of a chain transfer agent (CTA) or “RAFT agent” to mediate the polymerization via a reversible chain-transfer process. The RAFT agent can be any suitable chain transfer agent comprising substituted trithio groups (i.e. trithiocarbonates) substituted with various alkyl substituents. Dithioesters and xanthates substituted with various alkyl substituents can also be used as RAFT agents.

In certain embodiments, the RAFT agent is selected from the group consisting of 2-cyano-2-propyl dodecyl trithiocarbonate (CPDTC), 2-[[(butylsulfanyl)-carbonothioyl]sulfanyl] propanoic acid (PABTC), and 4-cyano-4-[(dodecylsulfanylthiocarbonyl)sulfanyl]pentanoic acid (CDSTS).

A radical initiator is used to start the reaction between the RAFT agent, the monoethylenically unsaturated aryl monomer and the polyethylenically unsaturated aryl monomer. The radical initiator may be thermally or photolytically activated. Suitable radical initiators include azo compounds such as azobisisobutyronitrile (AIBN) and 4,4′-azobis(4-cyanovaleric acid) (ACVA; also called 4,4′-azobis(4-cyanopentanoic acid)). Other suitable radical initiators include peroxide compounds such as benzoyl peroxide (BPO) or di-t-butyl peroxide (DTBP).

The reaction composition also comprises at least one liquid porogen. The porogen may be in the form of a pore forming solvent, a pore forming non-solvent, or a combination of both. In certain embodiment, the porogen comprises a pore forming solvent and a pore forming non-solvent.

The pore forming solvent may be toluene, tetrahydrofuran, dioxane or a mixture of any two or more of the aforementioned solvents.

The pore forming non-solvent may be an aliphatic hydrocarbon, aromatic hydrocarbon, ester, amide, alcohol, ketone, ether, and solutions of soluble polymers. In certain embodiments, the pore forming non-solvent is a C₆-C₂₂ aliphatic alcohol. Suitable aliphatic alcohols include decanol and dodecanol. In certain specific embodiments, the pore forming non-solvent is dodecanol.

The porogen may comprise at least 25 wt% of the pore forming solvent, such as 25 wt%, 26 wt%, 27 wt%, 28 wt%, 29 wt%, 30 wt%, 31 wt%, 32 wt%, 33 wt%, 34 wt%, 35 wt%, 36 wt%, 37 wt%, 38 wt%, 39 wt%, 40 wt%, 41 wt%, 42 wt%, 43 wt%, 44 wt%, 45 wt%, 46 wt%, 47 wt%, 48 wt%, 49 wt%, 50 wt%, 51 wt%, 52 wt%, 53 wt%, 54 wt%, 55 wt%, 56 wt%, 57 wt%, 58 wt%, 59 wt%, 60 wt%, 61 wt%, 62 wt%, 63 wt%, 64 wt%, 65 wt%, 66 wt%, 67 wt%, 68 wt%, 69 wt%, 70 wt%, 71 wt%, 72 wt%, 73 wt%, 74 wt%, 75 wt%, 76 wt%, 77 wt%, 78 wt%, 79 wt%, 80 wt%, 81 wt%, 82 wt%, 83 wt%, 84 wt%, 85 wt%, 86 wt%, 87 wt%, 88 wt%, 89 wt%, 90 wt%, 91 wt%, 92 wt%, 93 wt%, 94 wt%, 95 wt%, 96 wt%, 97 wt%, 98 wt%, 99 wt% or 100 wt% pore forming solvent.

Post polymerization, the porogen is removed from the internal structure of the copolymer monolith to form pores that separate the fused array of polymer microglobules and allow permeation of liquids or gases through the monolith.

The reaction composition may comprise from about 8 wt% to about 25 wt% of the monoethylenically unsaturated aryl monomer, from about 8 wt% to about 25 wt% of the polyethylenically unsaturated aryl monomer, from about 16 wt% to about 67 wt% of the pore forming solvent, from about 0 wt% to about 50 wt% of the pore forming non-solvent (all percentages are with respect to the total mass of monomers plus porogen). For example, the reaction composition may comprise from about 8.3 wt% to about 25 wt% of the monoethylenically unsaturated aryl monomer, from about 8.3 wt% to about 25 wt% of the polyethylenically unsaturated aryl monomer, from about 16.6 wt% to about 66.6 wt% of the pore forming solvent, from about 0 wt% to about 50 wt% of the pore forming non-solvent (all percentages are with respect to the total mass of monomers plus porogen). The amount of RAFT agent may comprise from about 1 to 2 molar ratio with respect to the initiator amount. The amount of the initiator is about 1 wt% with respect to total amount of the monomer amount.

As described in more detail later, in the methods described herein a solid copolymer network that is phase separable from the reaction composition is formed in a polymerization-induced phase separation (PIPS) process. In these methods, the monomers are dissolved in porogen(s), and then this homogeneous solution is polymerized in the presence of the initiator.

The reaction composition is formed by mixing the aforementioned components together in any suitable manner. Following mixing, the reaction composition is introduced to a mold having a shape and dimensions suitable for forming the liquid chromatography substrate. A suitable mold can be used to fabricate the porous copolymer monolith substrate in situ in any format, shape or size suitable for the intended application of the substrate. For example, the reaction composition can be added to a chromatographic column or capillary for fabricating a porous copolymer monolith substrate for LC applications. It is also possible to fabricate porous copolymer monolith substrate in the format of flat sheets for LC and/or thin layer chromatography (TLC) applications.

In certain embodiments, the reaction composition is introduced into capillary tubing, for example 200 µm I.D. capillary tubing. The capillary tubing may comprise a modified inner wall in which the inner wall surface is modified to provide a covalent attachment of the polymer to the surface. The inner wall modification may comprise grafting double bond functionality onto the surface. The double bond functionality may be provided by acrylate or methacrylate groups. For example, the inner surface could be treated with an acryl- or methacrylsilane to introduce acrylate or methacrylate functionalities onto the inner wall surface. In certain embodiments, the inner wall surface is treated to introduce acrylate functionality to the surface.

The monoethylenically unsaturated aryl monomer, the polyethylenically unsaturated aryl monomer and the RAFT agent are copolymerised in the mold. The polymerization reaction is initiated using the suitable radical initiator. In certain embodiments, the radical initiator is AIBN which is activated thermally at a temperature of from about 40° C. to about 100° C., such as from about 60° C. to about 100° C. In certain embodiments, the AIBN is activated thermally at a temperature of 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C. or 100° C.

As an alternative, the initiator may be activated using ultraviolet (UV) or visible light.

The reaction composition in the mold is maintained under conditions to form a solid copolymer network that is phase separable from the reaction composition and/or any liquid components. This may be achieved by maintaining the reaction composition in the mold at a desired temperature. The temperature of the reaction composition may be maintained at the desired temperature using any suitable heating apparatus, such as a heated water bath, an oven, or the like.

Phase separation during the polymerization reaction occurs as the monomers react to form a solid polymer network with pockets or porogen embedded in the polymer network. This technique is known as polymerization-induced phase separation (PIPS). More specifically, upon polymerization the solubility of the growing polymer network in the reaction composition and/or associated liquid(s) decreases and the polymer starts to gel. The gelling polymer locks in droplets of the porogen. The droplet size and the morphology of droplets are determined during the time between the droplet nucleation/initiation of network formation and the gelling of the polymer. Factors that determine morphology of the solid copolymer network include the rate of polymerization, the relative concentrations of materials, the temperature, the types of polymers used and other physical parameters, such as viscosity, solubility of the porogen in the polymer. Reasonably uniform sized droplets of porogen can be achieved by this technique.

Other phase separation polymerization techniques could also be used to bring about phase separation during the polymerization. Suitable techniques include thermal induced phase separation (TIPS) and solvent-induced phase separation (SIPS) in which the phase separation can be achieved by changing temperature or adding a solvent, respectively.

The phase separated solid copolymer network is then separated from the reaction composition to provide the porous copolymer monolith substrate.

Following separation of the solid copolymer network from the reaction composition the porogen may be removed from the porous copolymer monolith substrate. Removal of the porogen produces an interconnected continuous macroporous polymer which allows a fast liquid transport through the percolating macropores. The porogen can be removed from the porous copolymer monolith substrate using any suitable process. For example, the porous copolymer monolith substrate can be purified by contacting the substrate with a solvent in which the porogen is soluble under conditions to extract the porogen from the substrate. Suitable solvents for this purpose include volatile alcohol solvents such as methanol, ethanol, and isopropanol, acetone, acetonitrile and tetrahydrofuran. For example, the porogen can be removed from the substrate by Soxhlet extraction with a solvent for purification of bulk polymer. When the monoliths are prepared in a column format for LC, the monolithic columns can be washed to remove the porogen by flushing a solvent through the column. Following removal of the porogen, the purified substrate can be dried. For example, the substrate may be dried to constant weight under vacuum at an elevated temperature.

The methods described herein lead to copolymer monolith substrates having smaller pore size than known organic polymer-based substrates which typically have pore sizes in the range of about 300 nm to about 5000 nm. The specific surface area of copolymer monolith substrates formed according to the present disclosure when measured by nitrogen adsorption-desorption isotherms may be greater than 10 m²/g. In certain embodiments, the BET surface area of the porous copolymer monolith substrate is greater than 40 m²/g, greater than 100 m²/g or greater than 500 m²/g.

Also disclosed herein is a porous copolymer monolith substrate for use in flow through liquid chromatography applications. The porous copolymer monolith substrate comprises a porous copolymer monolith covalently attached to an internal surface of a liquid chromatography column, wherein the porous copolymer monolith has been formed by copolymerising a reaction composition comprising a monoethylenically unsaturated aryl monomer, a polyethylenically unsaturated aryl monomer and a RAFT agent under conditions to form a solid copolymer network that is phase separated from the reaction composition and/or any liquid components and is covalently attached to the internal surface of the liquid chromatography column, and wherein the copolymerising is carried out in the presence of at least one porogen.

Also disclosed herein is a separation medium comprising a porous polymer monolith formed by the methods as described herein.

The methods described herein allow for a high level of control leading to materials with smaller pore size than known organic polymer-based substrates. Without intending to be bound by theory, the applicant proposes that the PIPS approach affects the kinetics of polymerization and this allows for greater control and homogeneity in the substrates formed. This can be contrasted with the methods used to form known organic polymer-based substrates for which polymerization is often started via a thermal radical initiator resulting in growing polymer chains following crosslinking and gelation steps. The typical cauliflower-like morphology is obtained and this can be poorly tuned by manipulating different variables affected on different polymerization steps¹¹, often resulting in an inhomogeneous structure.

Living / controlled radical polymerization processes (CRPs) have been widely studied for preparation of 3D crosslinked polymers with a tunable topology, composition and functionality. ¹²⁻¹⁶ Among these methods it can be mentioned atom transfer radical polymerization (ATRP)¹⁷, stable free radical (SFR) mediated living polymerization¹⁸, organotellurium-mediated living radical polymerization (TERP)¹⁹ and the reversible addition-fragmentation chain transfer (RAFT)²⁰⁻²¹ polymerization. Utilizing these CRP methods in PIPS strategy, which we refer to as “Controlled-PIPS” thus offers new approaches for preparation of well-defined 3D structural materials. As an example, Hillmyer and co-workers reported the preparation of hierarchically porous polymers by polymerization-induced micro-phase separation (PIMS).²²⁻²⁷ In that method, the poly(lactide) segment locks domains during the polymerization and the CRP agent provides control over the growing chain length and as result of that changing the time of the gelation and further the precipitation step. ^{8, 20, 28-29}

Besides the simplicity, methods described herein are versatile with respect to further functionalization via surface grafting from retained initiator or transfer agent functionality within the porous substrates. In flow through applications, the presence of functionality on the surface of pores is highly desirable as liquid is transported through the continuous pore systems where the interaction occurs with the scaffold. The RAFT polymerization has been utilized for preparation of monolithic polymer within the liquid chromatography column and further grafting of a functional group on the surface has been demonstrated.³⁰ The subsequent grafting of monomers with phosphine functionality was utilized in catalysts for Michael addition in flow synthesis.³¹ In the present case, functional groups, such as hydroxyl groups or phosphine groups, may be grafted onto the substrates. Other materials that could be grafted onto the substrates include hydrophilic based polymers, hydrophobic based polymers, positively charged polymers, and negatively charged polymers.

Thus, we have designed a series of well-defined porous polymeric materials under RAFT polymerization. The effect of the RAFT agent type and amount as well as pore forming agent on the phase separation of polymer network were studied. These materials were characterized by in situ NMR experiments, nitrogen adsorption-desorption experiments, elemental analysis, field-emission scanning electron microscopes (FE-SEM), SEM-energy-dispersive X-ray spectroscopy (SEM-EDX) as well as Time-of-Flight Secondary Ion Mass Spectrometry (ToF-SIMS). The novel prepared 3D cross-linked porous polymers were then synthesized within fused-silica capillaries and applied as stationary phases for micro-scale liquid chromatography of peptide and protein mixtures (micro-LC). The manipulation of functional groups on the polymer surface via removing the end group of the retained transfer agent functionality for the RAFT agent and its effect on the separation performance was carried out. Furthermore, an excellent separation of biomolecules (a mixture of seven peptides as well as five proteins (standard mixture)) was demonstrated.

### EXAMPLES

### Example 1 - Polymerization of Styrene-Based Monolithic Porous Polymers

### Materials

Azoisobutyronitrile (AIBN, 12 wt% in acetone), basic alumina (Al₂O₃), styrene (Sty, 99% purity), divinylbenzene (DVB, 80% purity), organic solvents and RAFT agents 2-cyano-2-propyl dodecyl trithiocarbonate (CPDTC) and 4-cyano-4-[(dodecylsulfanylthiocarbonyl)sulfanyl]pentanoic acid (CDSTS) were purchased from Sigma-Aldrich and used as received. The RAFT agent, 2-[[(butylsulfanyl)-carbonothioyl]sulfanyl] propanoic acid (PABTC), was synthesized as described in Ferguson et al.³⁴ Sty and DVB were passed through a column of Al₂O₃ to remove the inhibitor. Fused-silica capillaries with 200 µm I.D. and 375 µm O.D. were purchased from Polymicro Technologies (Phoenix, AZ, US). All other solvents were purchased from Sigma-Aldrich and were used as received.

### Process

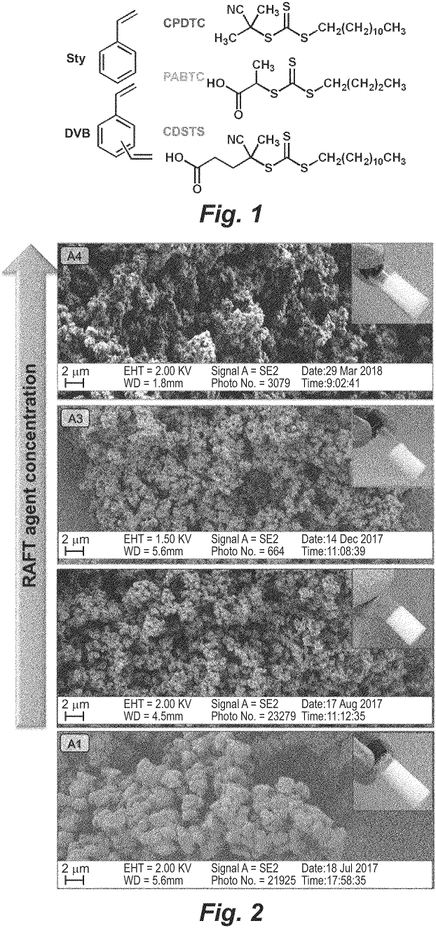

A desired amount of the RAFT agent and AIBN initiator were dissolved in styrene and divinylbenzene in a glass container. The pore forming agent, 1-dodecanol and toluene were added to the container. The yellow transparent solution was shaken for 2 minutes and then deoxygenated with nitrogen for 10 minutes. The precursor was then cured in a water bath at 60° C. for 24 h. The resulting polymer was purified via Soxhlet extraction with methanol for 48 h. The purified monolith was dried in a vacuum oven at 30° C. for at least 72 h to constant weight. The chemical structures of the monomer, crosslinker and RAFT agents are shown in FIG. 1. Further, for in situ polymerization, the polymer precursor was introduced into a modified inner wall capillary tubing. The surface modification provides a covalent attachment of the polymer to the surface of silica capillary. The experimental conditions used for the preparation of the different porous polymers can be found in Table 1.

TABLE 1

Polymeric monoliths synthesized in this study

| Sample code | [CTA]/ [AIBN]^{a} | Pore forming agent^{b} | | Morphology |
|---|---|---|---|---|
| | | Organic solvent (Wt%)^{c} | Non-solvent (wt%)^{c} | |
| A1 | 0 | Toluene, 25 wt% | 75 wt% | inhomogeneo us |
| A2 | 1 | Toluene, 25 wt% | 75 wt% | homogeneous |
| A3 | 1.5 | Toluene, 25 wt% | 75 wt% | homogeneous |
| A4 | 2 | Toluene, 25 wt% | 75 wt% | inhomogeneo us |
| B1 | [PABTC]=1 | Toluene, 25 wt% | 75 wt% | homogeneous |
| B2 | [CDSTS]=1 | Toluene, 25 wt% | 75 wt% | homogeneous |
| C1 | 1 | Toluene, 15 wt% | 85 wt% | inhomogeneo us |
| C2 | 1 | Toluene, 7.5 wt% | 92.5 wt% | inhomogeneo us |
| C3 | 1 | Toluene, 0 wt% | 100 wt% | inhomogeneo us |
| D1 | 1 | THF, 25 wt% | 75 wt% | homogeneous |
| D2 | 1 | Dioxane, 25 wt%, | 75 wt% | homogeneous |

The molar ratio between chain transfer agent (CTA) and the AIBN (with respect to 1 mol of the AIBN). The amount of styrene and divinylbenzene were 2.88 mmol and 3.82 mmol, respectively. The selected RAFT agent is CPDTC ((2-Cyano-2-propyl dodecyl trithiocarbonate)) unless otherwise mentioned.^{b} The non-solvent (1-dodecanol) is miscible with monomers and organic solvent.^{c} The total mass of pore forming agent was the same and all amounts are based on the weight percentage (w.r.t. the pore forming portion).

### Characterization Techniques

In situ polymerization inside NMR analyses were performed using a Bruker Ultra Shield Avance Spectrometer (300 MHz) without using any deuterated solvents. The porous polymers were characterized by field emission gun scanning electron microscopy (FE-SEM) studies using a Zeiss Merlin FESEM used at an operating voltage of 2 kV. All samples were ~0.5 nm platinum coated in an argon atmosphere (AGB7234 High Resolution Sputter Coater).

The BET surface area and pore volume were determined by using nitrogen adsorption / desorption isotherms at -196° C. on Micromeritics ASAP 2420 analyzer. Prior to analysis, all porous polymers were degassed under vacuum for at least 10 h at 100° C. lysis. BET surface area was measured using the Brunauer-Emmett-Teller (BET) method in relative pressure range of P/P₀ 0.05-0.20. The t-plot method was used for calculation of total pore volume and surface area of micropores within the polymer. Mesopore volume was calculated as the difference of total pore volume and micropores volume.

The composition of the material was examined by EDX. Before analysis the materials were sputter-coated with carbon (Edwards carbon evaporator, model EXT 70H 24V, West Sussex, UK). Sulfur content was analyzed using CNS elemental analysis using a Leco Trumac CNS analyser. The sample mass was about 200 mg. X-ray photoelectron spectroscopy (XPS) spectra were recorded on a Kratos Axis Ultra DLD equipped with a monochromatic A1 Kα source (1486.6 eV). Each sample was analysed at an emission angle normal to the sample surface. Wide-scan spectra (1200 - 0 eV) were acquired at a pass energy of 160 eV and high resolution C 1 s spectra were acquired at 20 eV. Data were processed with CasaXPS (ver.2.3.19 Pre rel. 1.0, Casa Software Ltd). Prior to XPS measurements, all samples were degassed overnight under vacuum.

Time of Flight Secondary Ion Mass Spectrometry (ToF-SIMS) was performed using a PHI TRIFT V nanoTOF instrument (Physical Electronics Inc., Chanhassen, MN, USA) equipped with a pulsed liquid metal Au⁺ primary ion gun (LMIG), operating at 30kV energy. Dual charge neutralisation was provided by using 10 eV Ar⁺ ions and an electron flood gun (10 eV electrons). Experiments were performed under a vacuum (5×10⁻⁶ Pa or better). SIMS spectra were collected from at least five areas of 100×100 µm each, with an acquisition time of 1 minute in “bunched” mode to maximize spectral resolution. All images were acquired in an “unbunched” mode to maximize spatial resolution. Sample spectra were processed and interrogated using WincadenceN software V1.18.1 (Physical Electronics Inc., Chanhassen, MN, USA).

The liquid separations of biomolecule samples, namely protein and peptide standard samples, with the fabricated columns were performed by high performance liquid chromatography (HPLC) with an Agilent 1290 Infinity II (Agilent, Hanover, Germany) equipped with a UV detector. The mobile phase was an aqueous solution of acetonitrile with 1 wt% of trifluoroacetic acid. The detection was at 214 nm with a flow rate of 6 µL/min, an injection volume of 1µL, and a column temperature of 30° C. Conditions: 25 cm × 200 µm ID column; eluent A: 95:5 v/v water: acetonitrile 0.1% trifluoroacetic acid (TFA); eluent B: 5:95 v/v water: acetonitrile 0.1% TFA; linear gradient 1 to 65% B over 10 minutes; flow rate: 6 µL.min⁻¹; UV detection at 214 nm.

### Results

### RAFT Preparation of Porous Polymeric Materials

The preparation of homogeneous material with a well-defined pore size is highly desirable for flow through applications. A series of yellow transparent precursor solutions with different amounts of CPDTC (RAFT agent), were cured at 60° C. resulting in samples A2 to A4. For comparison purposes, the sample A1 without any RAFT agent was also prepared (See Table 1). After the washing process, the obtained materials A2-A4 retained their yellow colour highlighting the presence of trithiocarbonate group within the polymer. The presence of the RAFT agent (dissolved in toluene) had also a significant effect on the morphology of the resulting porous polymers as can be seen from the scanning electron microscopy (SEM) images (FIG. 2).

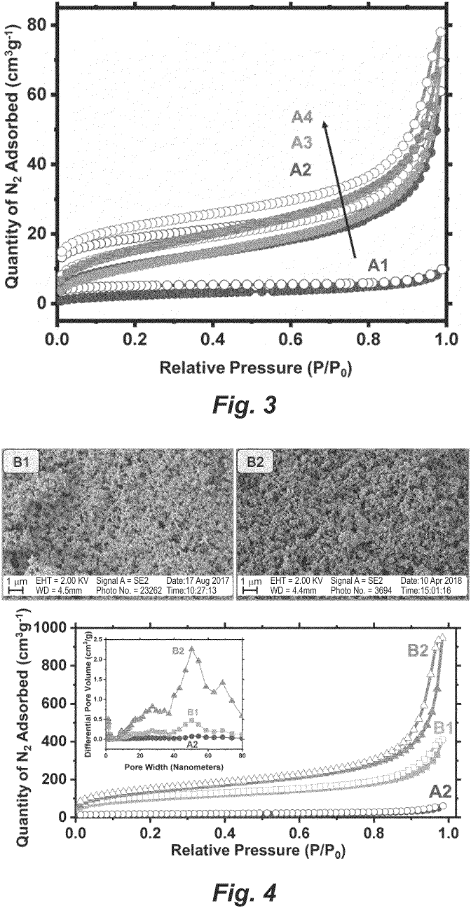

The BET surface area for sample A2 was 42.2 m²/g which is around 15 times more than the sample A1 (~2.8 m²/g). This highlights the effect of the RAFT polymerization. Increasing the amount of the RAFT agent for the sample A3 and A4 had no significant effect on the surface area. The isotherms for these polymers presented the typical type II hysteresis, for materials with macroporosities (FIG. 3).³⁵ In order to understand the pore networks, the textural parameters such as BET surface area, pore volume, and pore width, etc., were calculated by using nitrogen adsorption/desorption isotherms as shown in Table 2.

TABLE 2

Textural features of monolith samples

| | | | |
|---|---|---|---|
| SA_{BET} (m²/g) | Vₜ^{a} | Micropore area^{b} | Mesopore area^{c} |

| | | | | | | |
|---|---|---|---|---|---|---|
| Sample code | | | S_{micro} | Sₑₓₜ | V_{micro} | Vₘₑₛₒ |
| A1 | 2.8^{d} | - | - | 3.34 | - | - |
| A2 | 42.2 | 0.09 | - | 49.4 | - | 0.09 |
| A3 | 42.1 | 0.10 | - | 54.1 | - | 0.10 |
| A4 | 58.0 | 0.12 | - | 64.2 | - | 0.12 |
| B1 | 569.1 | 1.29 | 46.41 | 522.7 | 0.01 | 1.28 |
| B2 | 515.7 | 1.46 | - | 515.7 | - | 1.46 |
| C1 | 2.5 | - | - | 3.2 | - | - |
| C2 | 2.3 | - | - | 3.7 | - | - |
| C3 | 2.2 | - | - | 2.2 | - | - |
| D1 | 35.7 | 0.08 | - | 38.9 | - | 0.08 |
| D2 | 351.0 | 0.60 | 59.52 | 291.4 | 0.02 | 0.58 |

^{a}Vₜ (cm3/g): total pore volume. ^{b}S_{micro} (total micropore area), Sₑₓₜ (external surface area) and V_{micro} (micropore volume) were calculated based on the t-plot method. ^{c}Mesopore volume was calculated as the difference of Vt and Vmicro. The polymer were prepared without any CTA.

In comparison to sample A2, the same formula with different RAFT agents, PABTC (B1) and CDSTS (B2), were prepared. These polymers possessed very small pores (~50 nm) with similar isotherms as can be seen in FIG. 4. The surface area for B1 (569.1 m²/g) and B2 (515.7 m²/g) are significantly higher than A2 (i.e. the one prepared with CPDTC). As these materials were prepared using the same mole amount of RAFT agent, this highlights the morphology of the resulting porous polymer is strongly dependent on the type of the RAFT agent. We also observed control over the pore size distribution for sample B2, calculated by NLDFT method (FIG. 4, inset), suggesting a further work to find the effect of this RAFT agent on the pore size distribution of monolithic polymers.

### In Situ Preparation of Porous Monolithic Polymers in NMR Tubes

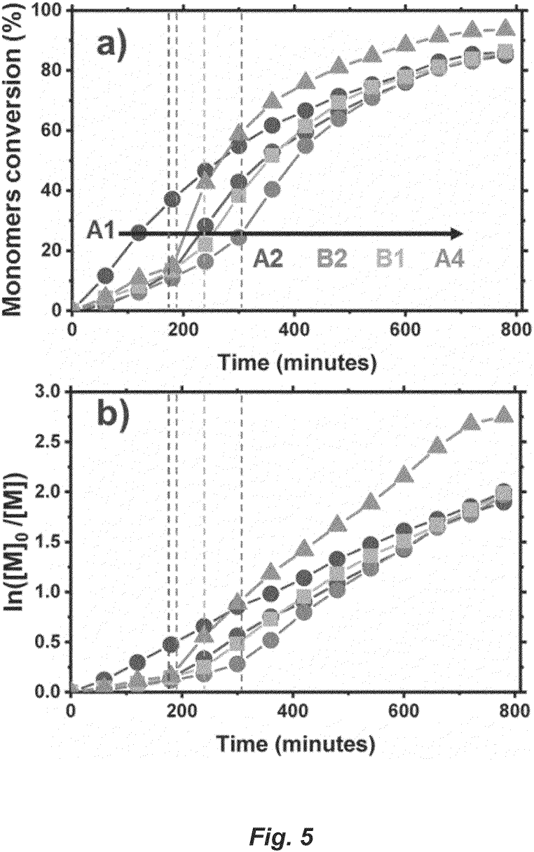

The ¹H NMR spectra recorded during the RAFT polymerization of Sty-co-DVB at 60° C. for samples A1, A2, A4 (in presence of CPDTC), B1 and B2 (in presence of PABTC and CDSTS, respectively) are shown in FIG. 5. The temperature of the probe in NMR instrument was set as 60° C. for at least 800 minutes. The monomer conversions were calculated by comparing the integrals of the vinyl monomer at 5.2 or 5.8 ppm to the t = 0 spectrum using 1-dodecanol as an internal standard. By applying heat, the polymerization starts and poly (Sty-co-DVB) chains begin to grow. As the RAFT agent is controlling the polymerization at this stage, the obtained chains are sufficiently short that they remain soluble, while random crosslinking is expected.

The presence of the CTA is delaying the phase separation, which is observable during the NMR study (See FIG. 4). The kinetic study and the rates of change for polymerization in presence of CPDTC (A2, A4) and PABTC (B1) are consistent with the result reported from previous work.³⁰ The dashed lines highlight the delay in phase separation time, from a few minutes for A1 (no RAFT agent) to ~300 minutes for monolith A4. The delay in phase separation is also visually observable, the yellow polymerization precursor remained transparent liquid while the A1 crosslinked to an opaque solid.

Comparing the slope of three different RAFT agents in FIG. 5(b) (semi-logarithmic plot) suggests that the behaviour of the CDSTS (as the RAFT agent) for sample B2 is different from the others after comparing the slopes of plots. After the gelation, a rapid polymerization can be observed with a faster rate to that observed in conventional polymerization (A1), which may be due to formation of a transient gel as a kinetic phenomenon.³⁶⁻³⁷

### Surface Composition of RAFT-Prepared Porous Monolithic Polymers

Once the polymerization reaction is complete, it is expected that the RAFT group is incorporated within the 3D scaffold. This provides a powerful tool for further tailoring the surface chemistry of the obtained materials. In order to find any differences in the surface chemistry of porous polymers prepared using different RAFT agents (A2 (CPDTC), B1 (PABTC) and B2 (CDSTS)), a series of different characterization techniques were used. The materials A2, B1 and B2 were characterized by X-ray photoelectron spectroscopy (XPS) analysis. The analysis depth of the XPS method is typically ~100 Å from top surface layer of the material. For A2, B1 and B2, a large abundance of carbon and oxygen were detected in the wide-scan elemental survey spectrum, as well as a small amount of sulfur (A2 (0.06%), B1 (0.11%) and B2 (0.13%)). While sulfur was detected in all samples, the lowest amount of sulfur was detected for the A2 sample, the sample with the most detected sulfur within the bulk. This highlights distinct differences between the surface and bulk chemical compositions and suggests a low percentage of the RAFT agent is present on the top the outermost layer.

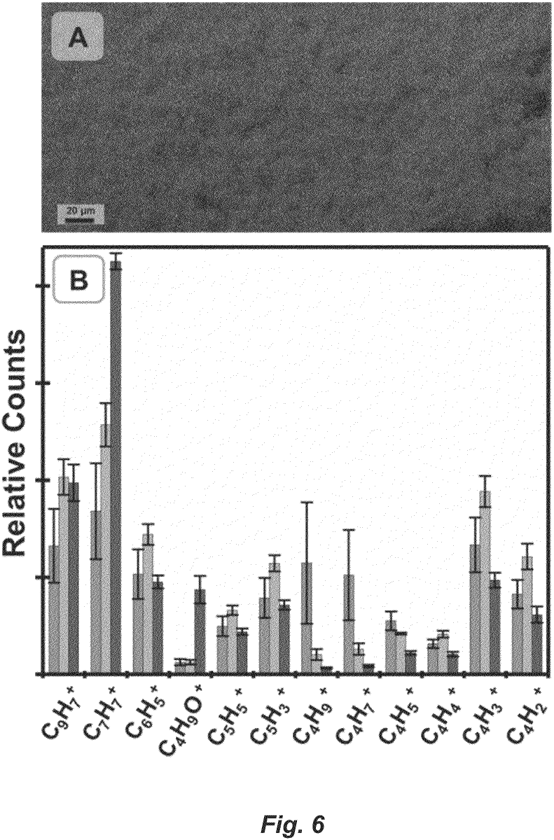

To further investigate the inclusion of the RAFT end-group within the surface, time-of-flight secondary ion mass spectrometry (ToF-SIMS) revealed differences in the surface chemistry of the materials A2, B1 and B2 (FIG. 6B). ToF-SIMS is a powerful and sensitive tool for analyzing the surface chemistry with high sensitive detection of lower molecular weight fragmented species in high mass resolution spectra (within ~30 Å top layer of the material). Tropylium ions (C₇H₇⁺) are often referred to as the most stable positive secondary ion from poly(styrene). As shown in FIG. 6B, we can compare the relative amount of the phenyl groups from the surface of the A2, B1 and B2. The materials B1(PABTC) and B2(CDSTS) show a similar amount of tropylium ions, high likely due to full surface coverage of polymers via the end-group of the RAFT agents, while the CPDTC (A2) has less coverage of the RAFT end-group on the top layer of the bulk materials. A higher amount of the C₄H₉O⁺ within A2 can be attributed to the trapped 1-dodecanol within the polymer globules.

### In Situ Synthesis of Porous Monolithic Polymers Containing Raft Inside a Capillary Format Columns

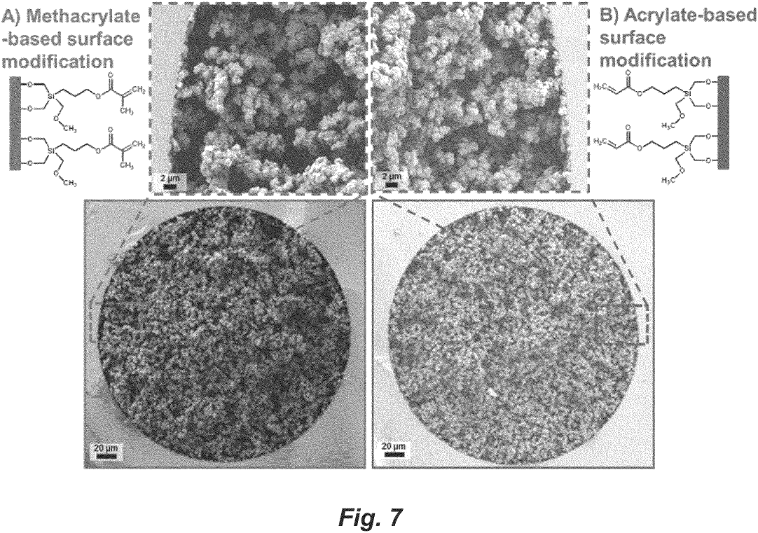

A uniform and robust attachment of monolith polymers to the inner wall of a column is highly important to ensuring the liquid phase flows solely through the voids of the porous polymers. With this in mind, the inner surface of the silica-fused capillary wall was chemically modified. Two different monomer classes (silane derivatives) were deposited on the surface, namely 3-(trimethoxysilyl)propyl methacrylate and 3-(trimethoxysilyl)propyl acrylate. While both monomers provided a covalent attachment, the latter method (deposited acrylate-based monomers) demonstrated a better attachment of the polymer to the surface judge by SEM images as well as a more stable back-pressure for the column when connected to the micro-LC pump (FIG. 7).

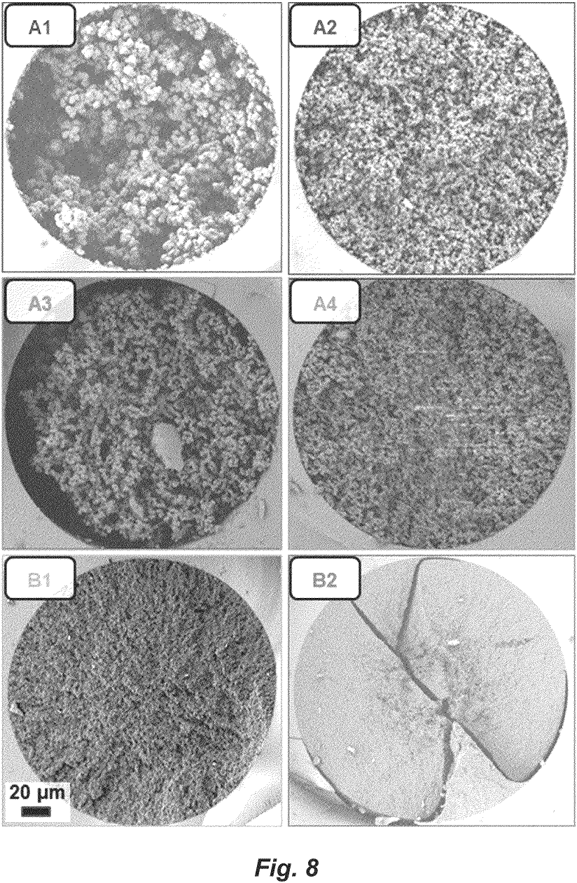

As the polymerization starts as a solution, the precursor composition of samples A1-A4 and B1-B2 were filled within a 35 cm length capillary (200 µm ID) and the obtained polymers adopted the format of the reactor. As seen in FIG. 8, the in situ preparation of materials with different amounts of CPDTC (A2 to A4), showed decreases in the observable globules. The pore sizes for column A4 and B1 were too small to allow passing of liquid through the column by using a pump. For columns A3 and B2, detachment of polymers from the inner wall were observed (FIG. 8; A3 and B2).

### Effect of the Composition of Pore Forming Agent

Following the successful formation of the monoliths within a confined space, we next turned our attention to study the role of the composition of pore forming agent on the polymer morphology and the attachment of the polymer to the inner surface of the capillary column. It is known that the amount and identity of the pore forming agent/s (porogen) dictates the morphology in terms of pore size and specific surface area. We believe that the pore forming agent is also providing a reaction medium for RAFT polymerization and changing the composition could potentially have an affect on the polymerization kinetics.³⁸

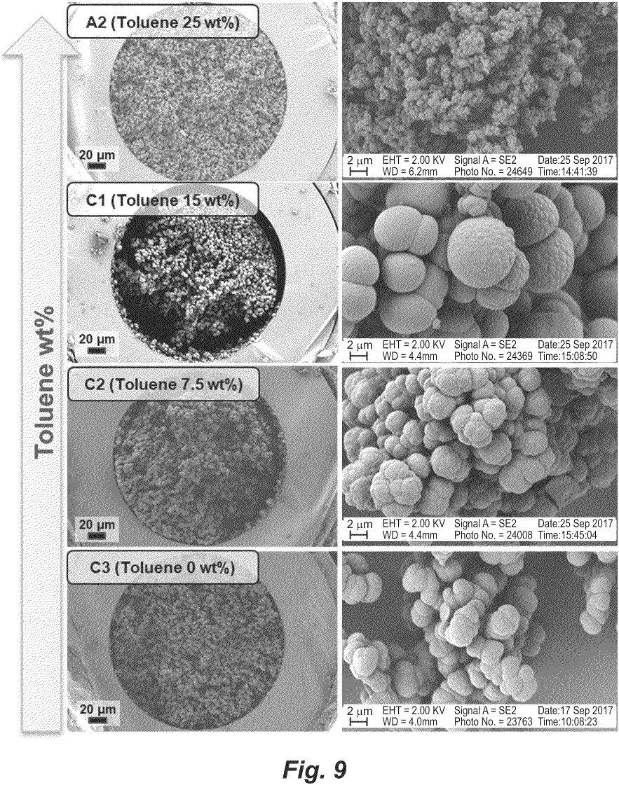

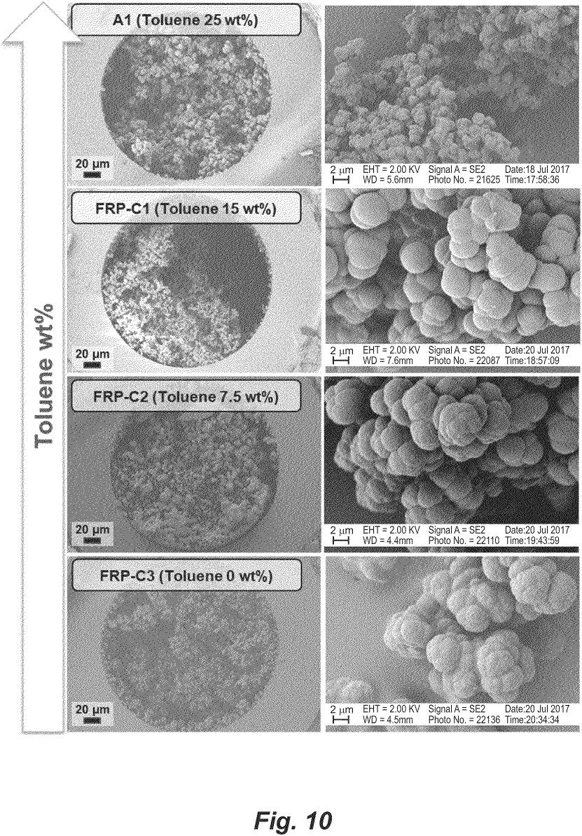

Comparing to the A2 sample, SEM images of the materials obtained using a lower amount of toluene is shown in FIG. 9. This might be due to activation of the RAFT agent and increased flow of radical species with RAFT end group to find the monomers. This result highlights that the amount of toluene (25 wt%) within the pore forming agent is the minimum requirement for observing a full attachment of the monolith on inner surface of the capillary column. The homogeneity of the bulk polymers formed with lower amounts of toluene decreased dramatically (Table 1). The amount of toluene (at least 25 wt%) has a crucial role in obtaining materials with a homogenous polymer structure attached to the inner wall on a capillary. For more investigation on the polymer attachment and the effect of the toluene, a series of similar recipes to the C1 to C3 were prepared under a free radical polymerization method, i.e. FRP-C1, FRP-C2 and FRP-C3, and a similar trend as the one seen with RAFT polymerization has been observed (FIG. 10).

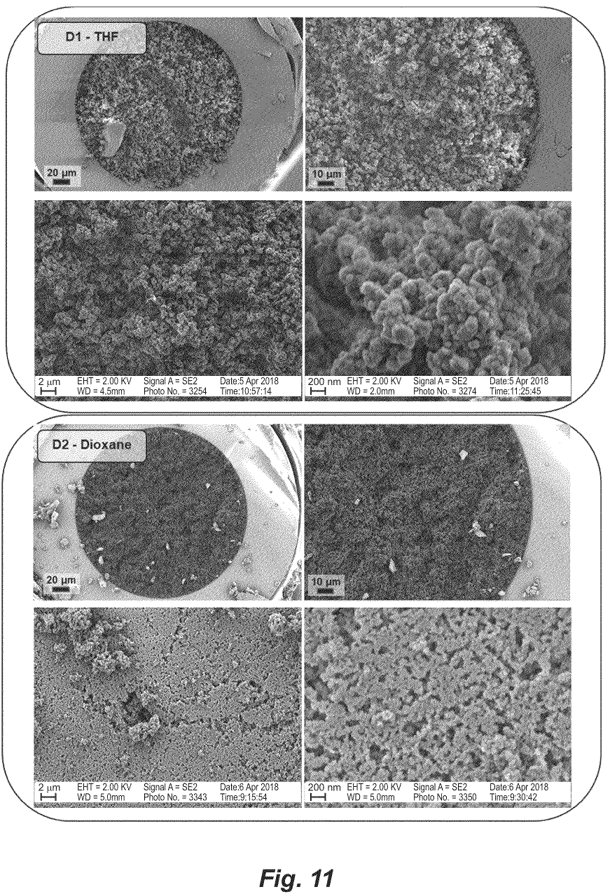

Further, the type of the organic solvent was changed to THF (D1) and dioxane (D2) with the same weight percentage as toluene in sample A2 (FIG. 11). While the BET surface area for D1 was around 35.7 m²/g, a high surface area was calculated for D2 (351.0 m²/g). The in situ polymerization of D2 within a capillary resulted in formation of a material with small percolating pores which did not allow liquid such as methanol to pass through the column. ForD1, a poor attachment of the monolith to the surface of the polymer was observed (FIG. 11).

### Evaluation of Porous Monolithic Polymers as Stationary Phases for Liquid Separation

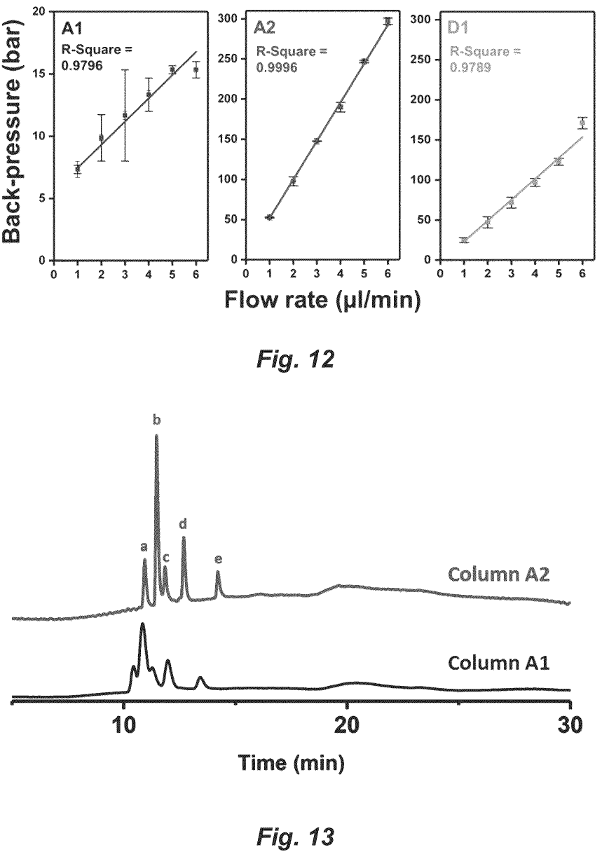

After the optimization experiments performed in the previous sections, A2 and D1 were tested as stationary phases for the separation of mixtures of large (proteins) and medium (peptides) molecular weight analytes. In order to understand the effect of using RAFT polymerization on the chromatographic performance, all results were compared against a Sty-co-DVB monolithic column prepared by conventional free-radical polymerization (A1). In terms of column permeability, FIG. 12 shows plots of column back pressure versus flow rate (n = 3 for each column) obtained for samples A1, A2 and D1.

We used Darcy’s law to estimate the permeability of columns A1, A2 and D1. Column permeability values (k_{p,f}) of 4.48×10⁻¹³ ±8.86×10⁻¹⁴ m² (A1- No CTA), 1.48×10⁻¹⁴ ±2.89×10⁻¹⁶ m² (A2- CPDTC CTA with toluene) and 2.58×10⁻¹⁴ ±6.03×10⁻¹⁶ m² were obtained. As expected, the lower permeability of columns A2 and D1 can be attributed to the smaller polymer globules as a result of delays in the onset of phase-separation. Further, we utilized the obtained column for a separation of five proteins under reversed-phase conditions (FIG. 13). Baseline protein separation with column A2 was achieved with good peak shapes, while poor separation performance was observed with column A1, judged by the peak shape. While the peak shape for column A2 was narrower, this result highlights that the super hydrophobicity of the styrene-based support is more important for the large molecule separations than the size of the pores.

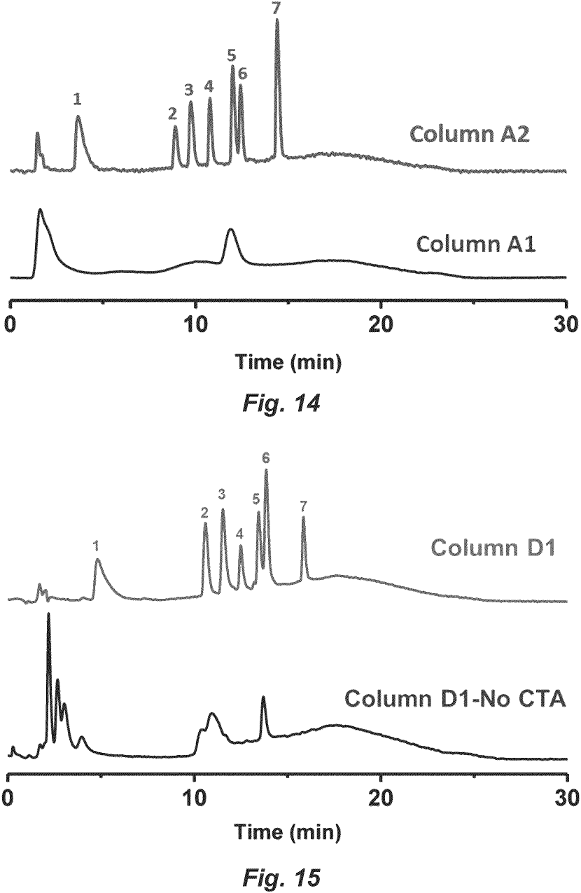

The separation of medium size molecules (peptides) revealed the main differences between these two columns, A2 (RAFT agent CPDTC with toluene) and A1 (no-CTA). As seen in FIG. 14, column A1 (no-CTA) showed no separation of seven peptide molecules, and A2 surprisingly demonstrated an excellent separation of peptides with high flow rate, i.e. 6 µL min⁻¹. The pore size is small enough to provide both fast and efficient separation performance for peptides. We have further observed a similar performance of peptide separation by using column D1 (prepared with CPDTC and THF) to the one observed with column A2. Also no CTA-D1 column resulted in no separation of peptides (FIG. 15).

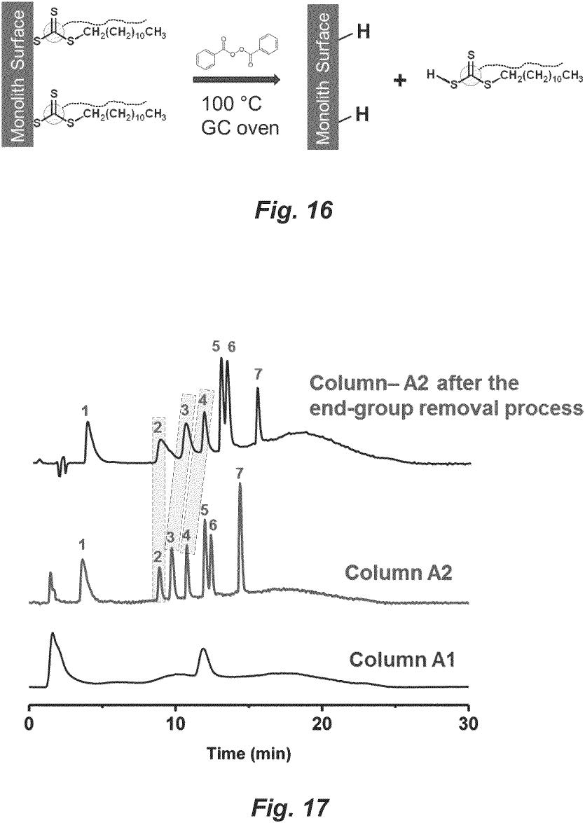

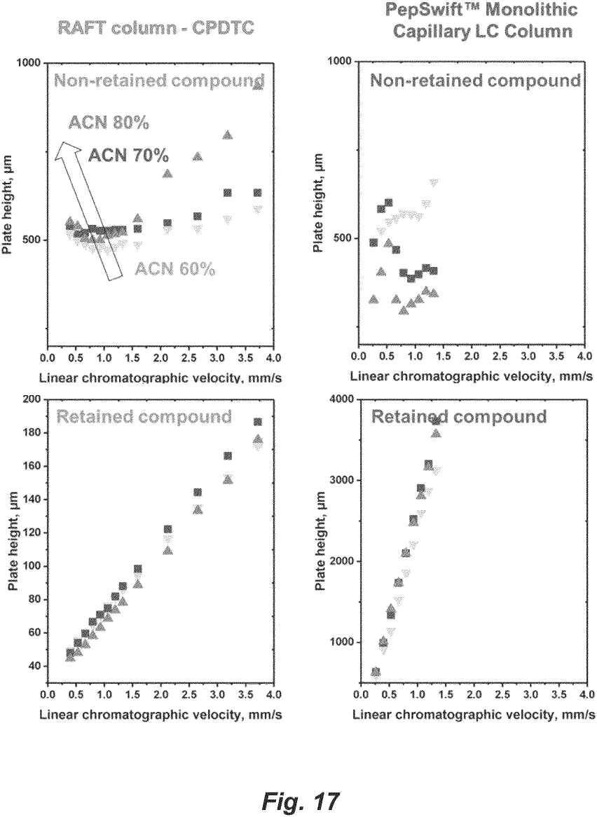

We then turned our attention to the role of trithiocarbonate group and C₁₂ from the materials (see FIG. 1 and FIG. 6). The above two comparisons between RAFT columns and no-CTA columns highlight the importance of the small pore size on the separation performance for peptides. Considering the presence of the RAFT-end group on the monolith surface, a typical RAFT-end group removal protocol with minor modifications was applied and C₁₂ were cleaved within the capillary column (FIG. 16).³⁹⁻⁴⁰ In the separation of peptides, the end-group removed column showed deformed peak shape in separation of three specific peptides; [Arg⁸]-Vasopressin acetate salt (peptide 2), Enkephalin acetate salt (peptide 3) and Leucine encephalin (peptide 4) (FIG. 17). These changes in peak shape for peptides, as well as the retention time, highlights the effect of the RAFT functionality on the peptide separation performance. A more detailed study of the separation of protein, peptides as well as small molecules using these columns is underway.

### Conclusions

In summary, we demonstrate a versatile one-pot route for in situ fabrication of porous polymers containing RAFT agent within capillary columns. This method provides control over polymerization kinetics as well as the morphology of the obtained porous polymer. These materials demonstrate an enhancement in mechanical properties of the material. Using multi-instrument characterization techniques provided essential information for understanding the surface composition of the obtained materials. Further, the application of these porous materials as a support in liquid separations was studied. More specifically, the separation of proteins and peptides via micro-liquid chromatography was demonstrated; the effect of the RAFT groups retained within the polymer on the separation performance was further studied via removing these groups.

Robust column preparation procedures are not always observed in the field of polymeric monolithic LC columns and is key when considering translation of the technology from lab- to large-scale production. The RAFT functionality on the surface of the monolithic materials provides a powerful substrate for subsequent surface chemistry reactions.

### Example 2 - Comparative Study

### Isocratic Mode

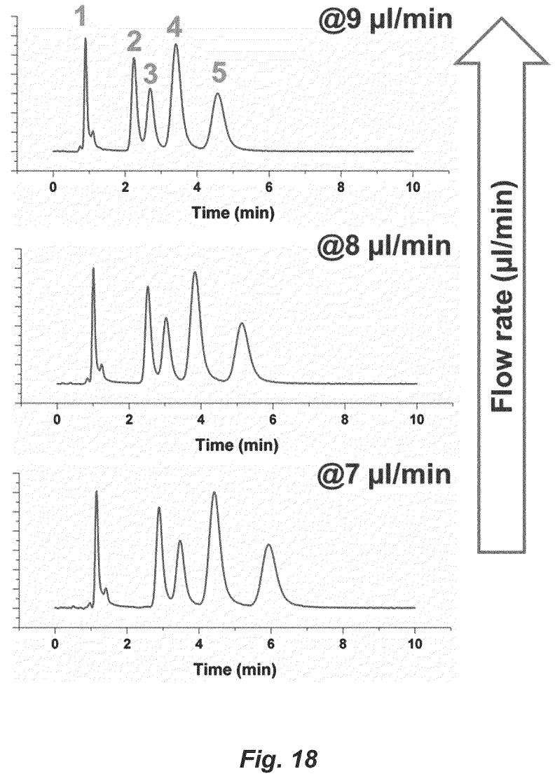

The retention of ethylbenzene in isocratic mode (mobile phase: acetonitrile 60% and H₂O 40%) was investigated for two columns (RAFT-prepared capillary column A2 200 µm I.D. x 250 mm length) and a commercially available PepSwift™ capillary column (200 µm I.D. x 250 mm length) (FIG. 18). Also, no retention of small molecules was observed using a commercially available ProSwift™ capillary column (200 µm I.D. x 250 mm length).

TABLE 3

Average retention factors for retained ethylbenzene with different mobile phase compositions

| | 60 ACN-40 Water | 70 ACN-30 Water | 80 ACN-20Water |
|---|---|---|---|
| Average retention factor K′_{RAFT} | 3.4 | 1.9 | 1.1 |
| Average retention factor | 3.2 | 1.8 | 1.0 |

### Gradient Mode

The peak capacity for the separation of peptides was calculated using equation 1:

$${n}_{c} = \frac{{t}_{G}}{1.7 {W}_{1 / 2}} + 1 \qquad \text{(1)}$$

where t_{G} is the gradient time and W_{½} the peak width at half height.

TABLE 4

Peak capacity calculated based on the equation (1)

| Type of column and the flow rate | n_{c} |
|---|---|
| RAFT prepared-column @6 µl/min | 18 |
| RAFT prepared-column @7 µl/min | 19 |
| RAFT prepared-column @8 µl/min | 20 |
| PepSwift™ @2 µl/min | 7 |
| ProSwift™ @7 µl/min | 20 |

In another way to calculate the peak capacity, peak widths were measured from the UV chromatograms at peak half-height, averaged, then subsequently converted to 4σ peak capacities according to equation 2:

$${P}_{c , 4 σ} = 1 + \left[\left(\frac{2.35}{4}\right) \left(\frac{{t}_{g r a d i e n t}}{{W}_{h , a v g}}\right)\right] \qquad \text{(2)}$$

TABLE 5

Peak capacity calculated based on the equation (2)

| Type of column and the flow rate | n_{c} |
|---|---|
| RAFT prepared-column @6 µl/min | 12 |
| RAFT prepared-column @7 µl/min | 10 |
| RAFT prepared-column @8 µl/min | 11 |
| PepSwift™ @2 µl/min | 7 |
| ProSwift™ @7 µl/min | 13 |

Equation (3) allows the permeability to be calculated.

$${k}_{p , f} = \frac{1.67 x {10}^{- 11} L η}{m A} \qquad \text{(3)}$$

The RAFT-prepared column demonstrated an excellent separation of small molecules (mix of toluene, ethylbenzene, propylbenzene and butylbenzene) in isocratic mode (ACN:Water 60:40, 70:30 @7 µl/min, @8 µl/min and @9 µl/min) (FIG. 19).

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

The reference to any prior art in this specification is not, and should not be taken as, an acknowledgement of any form of suggestion that such prior art forms part of the common general knowledge.

### REFERENCES

(1) Svec, F.; Frechet, J. M. J. New designs of macroporous polymers and supports: from separation to biocatalysis. Science 1996, 273 (5272), 205-211, DOI: 10.1126/science.273.5272.205.

(2) Talebi, M.; Nordborg, A.; Gaspar, A.; Lacher, N. A.; Wang, Q.; He, X. Z.; Haddad, P. R.; Hilder, E. F. Charge heterogeneity profiling of monoclonal antibodies using low ionic strength ion-exchange chromatography and well-controlled pH gradients on monolithic columns. J. Chromatogr., A 2013, 1317, 148-154, DOI: 10.1016/j.chroma.2013.08.061.

(3) Causon, T. J.; Shellie, R. A.; Hilder, E. F. High temperature liquid chromatography with monolithic capillary columns and pure water eluent. Analyst 2009, 134 (3), 440-442, DOI: 10.1039/B815886J.

(4) Desire, C. T.; Hilder, E. F.; Arrua, R. D., Monolithic High-Performance Liquid Chromatography Columns. In Encyclopedia of Analytical Chemistry, John Wiley & Sons, Ltd: 2017; pp 1-37.

(4a) Koku H.; Maier, R.S.; Czymmek, K.J.; Schure, M.R.; Lenhoff A.M., Modeling of flow in a polymeric chromatographic monolith J. Chromatogr., A 2011, 1218, 3466-3475, DOI:10.1016/j.chroma.2011.03.064.

(4b) Müllner, T., Zankel, A., Lv, Y., Svec, F., Höltzel, A. and Tallarek, U. (2015), Assessing Structural Correlations and Heterogeneity Length Scales in Functional Porous Polymers from Physical Reconstructions. Adv. Mater., 27: 6009-6013. doi:10.1002/adma.201502332.

(5) Svec, F.; Lv, Y. Advances and recent trends in the field of monolithic columns for chromatography. Anal. Chem. 2015, 87 (1), 250-273, DOI: 10.1021/ac504059c.

(6) Arrua, R. D.; Strumia, M. C.; Alvarez Igarzabal, C. I. Macroporous Monolithic Polymers: Preparation and Applications. Materials 2009, 2 (4), 2429-2466, DOI: 10.3390/ma2042429.

(7) Arrua, R. D.; Causon, T. J.; Hilder, E. F. Recent developments and future possibilities for polymer monoliths in separation science. Analyst 2012, 137 (22), 5179-5189, DOI: 10.1039/c2an35804b.

(8) Peters, E. C.; Svec, F.; Fréchet, J. M. J.; Viklund, C.; Irgum, K. Control of Porous Properties and Surface Chemistry in Molded Porous Polymer Monoliths Prepared by Polymerization in the Presence of TEMPO. Macromolecules 1999, 32 (19), 6377-6379, DOI: 10.1021/ma990538t.

(9) Müllner, T.; Zankel, A.; Svec, F.; Tallarek, U. Finite-size effects in the 3D reconstruction and morphological analysis of porous polymers. Mater. Today 2014, 17 (8), 404-411, DOI: 10.1016/j.mattod.2014.07.003.

(10) Mullner, T.; Zankel, A.; Mayrhofer, C.; Reingruber, H.; Holtzel, A.; Lv, Y.; Svec, F.; Tallarek, U. Reconstruction and characterization of a polymer-based monolithic stationary phase using serial block-face scanning electron microscopy. Langmuir 2012, 28 (49), 16733-16737, DOI: 10.1021/la3038395.

(11) Viklund, C.; Svec, F.; Fréchet, J. M. J.; Irgum, K. Monolithic, Molded, Porous Materials with High Flow Characteristics for Separations, Catalysis, or Solid-Phase Chemistry: Control of Porous Properties during Polymerization. Chem. Mater. 1996, 8 (3), 744-750, DOI: 10.1021/cm950437j.

(12) Braunecker, W. A.; Matyjaszewski, K. Controlled/living radical polymerization: Features, developments, and perspectives. Prog. Polym. Sci. 2007, 32 (1), 93-146, DOI: 10.1016/j.progpolymsci.2006.11.002.

(13) Coessens, V.; Pintauer, T.; Matyjaszewski, K. Functional polymers by atom transfer radical polymerization. Prog. Polym. Sci. 2001, 26 (3), 337-377, DOI: 10.1016/s0079-6700(01)00003-x.

(14) Hawker, C. J.; Bosman, A. W.; Harth, E. New Polymer Synthesis by Nitroxide Mediated Living Radical Polymerizations. Chem. Rev. 2001, 101 (12), 3661-3688, DOI: 10.1021/cr990119u.

(15) Perrier, S. 50th Anniversary Perspective: RAFT Polymerization-A User Guide. Macromolecules 2017, 50 (19), 7433-7447, DOI: 10.1021/acs.macromol.7b00767.

(16) Keddie, D. J. A guide to the synthesis of block copolymers using reversible-addition fragmentation chain transfer (RAFT) polymerization. Chem. Soc. Rev. 2014, 43 (2), 496-505, DOI: 10.1039/c3cs60290g.

(17) Kanamori, K.; Hasegawa, J.; Nakanishi, K.; Hanada, T. Facile Synthesis of Macroporous Cross-Linked Methacrylate Gels by Atom Transfer Radical Polymerization. Macromolecules 2008, 41 (19), 7186-7193, DOI: 10.1021/ma800563p.

(18) Viklund, C.; Nordstrom, A.; Irgum, K.; Svec, F.; Frechet, J. M. J. Preparation of porous poly(styrene-co-divinylbenzene) monoliths with controlled pore size distributions initiated by stable free radicals and their pore surface functionalization by grafting. Macromolecules 2001, 34 (13), 4361-4369, DOI: 10.1021/ma001435+.

(19) Hasegawa, G.; Kanamori, K.; Ishizuka, N.; Nakanishi, K. New monolithic capillary columns with well-defined macropores based on poly(styrene-co-divinylbenzene). ACS Appl. Mater. Interfaces 2012, 4 (5), 2343-2347, DOI: 10.1021/am300552q.

(20) Norisuye, T.; Morinaga, T.; Tran-Cong-Miyata, Q.; Goto, A.; Fukuda, T.; Shibayama, M. Comparison of the gelation dynamics for polystyrenes prepared by conventional and living radical polymerizations: a time-resolved dynamic light scattering study. Polymer 2005, 46 (6), 1982-1994, DOI: 10.1016/j.polymer.2004.12.043.

(21) Moad, G.; Rizzardo, E.; Thang, S. H. Radical addition-fragmentation chemistry in polymer synthesis. Polymer 2008, 49 (5), 1079-1131, DOI: 10.1016/j.polymer.2007.11.020.

(22) Seo, M.; Hillmyer, M. A. Reticulated nanoporous polymers by controlled polymerization-induced microphase separation. Science 2012, 336 (6087), 1422-1425, DOI: 10.1126/science.1221383.

(23) Seo, M.; Murphy, C. J.; Hillmyer, M. A. One-Step Synthesis of Cross-Linked Block Polymer Precursor to a Nanoporous Thermoset. ACS Macro Letters 2013, 2 (7), 617-620, DOI: 10.1021/mz400192f.

(24) Saba, S. A.; Mousavi, M. P.; Buhlmann, P.; Hillmyer, M. A. Hierarchically Porous Polymer Monoliths by Combining Controlled Macro- and Microphase Separation. J. Am. Chem. Soc. 2015, 137 (28), 8896-8899, DOI: 10.1021/jacs.5b04992.

(25) Chopade, S. A.; So, S.; Hillmyer, M. A.; Lodge, T. P. Anhydrous Proton Conducting Polymer Electrolyte Membranes via Polymerization-Induced Microphase Separation. ACS Appl. Mater. Interfaces 2016, 8 (9), 6200-10, DOI: 10.1021/acsami.5b12366.

(26) Mousavi, M. P.; Saba, S. A.; Anderson, E. L.; Hillmyer, M. A.; Buhlmann, P. Avoiding Errors in Electrochemical Measurements: Effect of Frit Material on the Performance of Reference Electrodes with Porous Frit Junctions. Anal. Chem. 2016, 88 (17), 8706-8713, DOI: 10.1021/acs.analchem.6b02025.

(27) Chopade, S. A.; Au, J. G.; Li, Z.; Schmidt, P. W.; Hillmyer, M. A.; Lodge, T. P. Robust Polymer Electrolyte Membranes with High Ambient-Temperature Lithium-Ion Conductivity via Polymerization-Induced Microphase Separation. ACS Appl. Mater. Interfaces 2017, 9 (17), 14561-14565, DOI: 10.1021/acsami.7b02514.

(28) Liu, K.; Aggarwal, P.; Tolley, H. D.; Lawson, J. S.; Lee, M. L. Fabrication of highly cross-linked reversed-phase monolithic columns via living radical polymerization. J. Chromatogr., A 2014, 1367, 90-98, DOI: 10.1016/j.chroma.2014.09.046.

(29) Wei, Z.-H.; Mu, L.-N.; Huang, Y.-P.; Liu, Z.-S. Imprinted monoliths: Recent significant progress in analysis field. Trends Anal. Chem. 2017, 86, 84-92, DOI: 10.1016/j.trac.2016.10.009.

(30) Barlow, K. J.; Hao, X.; Hughes, T. C.; Hutt, O. E.; Polyzos, A.; Turner, K. A.; Moad, G. Porous, functional, poly(styrene-co-divinylbenzene) monoliths by RAFT polymerization. Polym. Chem. 2014, 5 (3), 722-732, DOI: 10.1039/c3py01015e.

(31) Barlow, K. J.; Bernabeu, V.; Hao, X.; Hughes, T. C.; Hutt, O. E.; Polyzos, A.; Turner, K. A.; Moad, G. Triphenylphosphine-grafted, RAFT-synthesised, porous monoliths as catalysts for Michael addition in flow synthesis. React. Funct. Polym. 2015, 96, 89-96, DOI: 10.1016/j.reactfunctpolym.2015.09.008.

(32) Khodabandeh, A.; Arrua, R. D.; Mansour, F. R.; Thickett, S. C.; Hilder, E. F. PEO-based brush-type amphiphilic macro-RAFT agents and their assembled polyHIPE monolithic structures for applications in separation science. Sci. Rep. 2017, 7 (1), 7847, DOI: 10.1038/s41598-017-08423-x.

(33) Candish, E.; Khodabandeh, A.; Gaborieau, M.; Rodemann, T.; Shellie, R. A.; Gooley, A. A.; Hilder, E. F. Poly(ethylene glycol) functionalization of monolithic poly(divinyl benzene) for improved miniaturized solid phase extraction of protein-rich samples. Anal. Bioanal. Chem. 2017, 409 (8), 2189-2199, DOI: 10.1007/s00216-016-0164-y.

(34) Ferguson, C. J.; Hughes, R. J.; Nguyen, D.; Pham, B. T. T.; Gilbert, R. G.; Serelis, A. K.; Such, C. H.; Hawkett, B. S. Ab Initio Emulsion Polymerization by RAFT-Controlled Self-Assembly. Macromolecules 2005, 38 (6), 2191-2204, DOI: 10.1021/ma048787r.

(35) Cychosz, K. A.; Guillet-Nicolas, R.; Garcia-Martinez, J.; Thommes, M. Recent advances in the textural characterization of hierarchically structured nanoporous materials. Chem. Soc. Rev. 2017, 46 (2), 389-414, DOI: 10.1039/c6cs00391e.

(36) Lu, P. J.; Zaccarelli, E.; Ciulla, F.; Schofield, A. B.; Sciortino, F.; Weitz, D. A. Gelation of particles with short-range attraction. Nature 2008, 453 (7194), 499-503, DOI: 10.1038/nature06931.

(37) Tanaka, H. Viscoelastic phase separation. Journal of Physics: Condensed Matter 2000, 12 (15), R207-R264, DOI: 10.1088/0953-8984/12/15/201.

(38) Hird, N.; Hughes, I.; Hunter, D.; Morrison, M. G. J. T.; Sherrington, D. C.; Stevenson, L. Polymer discs — An alternative support format for solid phase synthesis. Tetrahedron 1999, 55 (31), 9575-9584, DOI: 10.1016/s0040-4020(99)00503-7.

(39) Khodabandeh, A.; Arrua, R. D.; Coad, B. R.; Rodemann, T.; Ohigashi, T.; Kosugi, N.; Thickett, S. C.; Hilder, E. F. Morphology control in polymerised high internal phase emulsion templated via macro-RAFT agent composition: visualizing surface chemistry. Polym. Chem. 2018, 9 (2), 213-220, DOI: 10.1039/c7py01770g.

(40) Moad, G.; Rizzardo, E.; Thang, S. H. End-functional polymers, thiocarbonylthio group removal/transformation and reversible addition-fragmentation-chain transfer (RAFT) polymerization. Polym. Int. 2011, 60 (1), 9-25, DOI: 10.1002/pi.2988.

1. A method for producing a porous copolymer monolith substrate for use in flow through liquid chromatography applications, the method comprising:
forming a reaction composition comprising at least one monoethylenically unsaturated aryl monomer, at least one polyethylenically unsaturated aryl monomer, a RAFT agent, at least one liquid porogen, and a radical initiator;
introducing the reaction composition to a mold having a shape and dimensions suitable for forming a liquid chromatography subtrate;
copolymerising the monoethylenically unsaturated aryl monomer, the polyethylenically unsaturated aryl monomer and the RAFT agent in the mold under conditions to form a solid copolymer network that is phase separated from the reaction composition and/or any liquid components;
separating the solid copolymer network from the reaction composition and/or any liquid components to provide the porous copolymer monolith substrate.

2. The method of claim 1, further comprising removing porogen from the porous copolymer monolith substrate.

3. The method of claim 1, wherein the RAFT agent is selected from the group consisting of 2-cyano-2-propyl dodecyl trithiocarbonate (CPDTC), 2-[[(butylsulfanyl)-carbonothioyl]sulfanyl] propanoic acid (PABTC), and 4-cyano-4-[(dodecylsulfanylthiocarbonyl)sulfanyl]pentanoic acid (CDSTS).

4. The method of claim 3, wherein the RAFT agent is selected from the group consisting of 2-[[(butylsulfanyl)-carbonothioyl]sulfanyl] propanoic acid (PABTC), and 4-cyano-4-[(dodecylsulfanylthiocarbonyl)sulfanyl]pentanoic acid (CDSTS).

5. The method of claim 1, wherein the monoethylenically unsaturated aryl monomer is an aryl monovinyl monomer.

6. The method of claim 5, wherein the aryl monovinyl monomer is selected from one or more of the group consisting of styrene, vinylnaphthalene, vinylanthracene and their ring substituted derivatives wherein the substituents include C₁-C₁₈ alkyl, hydroxyl, C₁-C₁₈ alkyloxy, halogen, nitro, amino or C₁-C₁₈ alkylamino groups.

7. The method of claim 6, wherein the aryl monovinyl monomer is styrene or a ring substituted derivative thereof wherein the substituents include C₁-C₁₈ alkyl, hydroxyl, C₁-C₁₈ alkyloxy, halogen, nitro, amino or C₁-C₁₈ alkylamino groups.

8. The method of claim 1, wherein the polyethylenically unsaturated aryl monomer is an aryl polyvinyl monomer.

9. The method of claim 8, wherein the aryl polyvinyl monomer is selected from one or more of the group consisting of divinylbenzene and divinylnaphthalene and their ring substituted derivatives wherein the substituents include C₁-C₁₈ alkyl, hydroxyl, C₁-C₁₈ alkyloxy, halogen, nitro, amino or C₁-C₁₈ alkylamino groups.

10. The method of claim 9, wherein the aryl polyvinyl monomer is divinylbenzene or a ring substituted derivative thereof wherein the substituents include C₁-C₁₈ alkyl, hydroxyl, C₁-C₁₈ alkyloxy, halogen, nitro, amino or C₁-C₁₈ alkylamino groups.

11. The method of claim 1, wherein the porogen comprises a porogenic solvent and a porogenic non-solvent.

12. The method of claim 11, wherein the porogenic solvent is selected from the group consisting of toluene, tetrahydrofuran and dioxane.

13. The method of claim 11, wherein the porogenic non-solvent is selected from the group consisting of aliphatic hydrocarbon, aromatic hydrocarbon, ester, amide, alcohol, ketone, ether, and solutions of soluble polymers.

14. The method of claim 13, wherein the pore forming non-solvent is a C₆-C₂₂ aliphatic alcohol.

15. The method of claim 14, wherein the pore forming non-solvent is selected from the group consisting of decanol and dodecanol.

16. The method of claim 15, wherein the pore forming non-solvent is dodecanol.

17. The method of claim 11, wherein the porogen comprises at least 25 wt% of the porogenic solvent.

18-20. (canceled)

21. The method of claim 1, wherein the BET surface area of the porous copolymer monolith substrate is greater than 500 m²/g.

22-42. (canceled)

43. A separation medium comprising a porous polymer monolith formed by the method of claim 1.

44. (canceled)

45. The use of the separation medium of claim 43 for liquid chromatography.
